(19) United States
(12) Patent Application Publication
(10) Pub. No.: US 2002/0133381 A1
(43) Pub. Date: Sep. 19, 2002

(54) Fare watcher

(76) Inventor: Kevin Tso, San Jose, CA (US)

Correspondence Address: CHRISTIE, PARKER & HALE, LLP, P.O. BOX 7068, PASADENA, CA, 91109-7068, US

(21) Appl. No.: 10/081,593

(22) Filed: Feb. 20, 2002

Related U.S. Application Data
(60) Provisional application No. 60/270,105, filed on Feb. 20, 2001.

(51) Int. Cl. G06F 17/60

(52) U.S. Cl. 705/5

(57) ABSTRACT

An electronic method for locating travel products for a user including requesting personal information from a user, receiving personal information from a user, requesting desired travel product attributes from a user, receiving desired travel product attributes from a user, searching a database of travel products to select desired travel products using desired travel product attributes received from a user, and reporting travel products selected to a user. The method also includes prompting a user to receive future notice about a travel product, receiving a request for future notice about a travel product from a user, searching through a database of travel products after a predetermined time interval to select desired travel products using desired travel product attributes received from a user, and notifying a user of selected travel products.

### CROSS-REFERENCE TO RELATED APPLICATION

This application claims priority of U.S. Provisional Patent Application No. 60/270,105, filed on Feb. 20, 2001, the entire contents of which are hereby incorporated herein by reference.

### BACKGROUND OF THE INVENTION

Travel products, such as airline tickets, rental cars, hotels, cruises, and tours, have prices that frequently fluctuate. Sometimes, the prices change several times in the same day. Other times, such as with cruises and tours, prices change less often, perhaps a couple of times a month. Itineraries that are further out in the future tend to change less, while itineraries closer in time tend to fluctuate more.

Currently, a consumer may research price information about a travel product. However, a consumer may not be ready to purchase the travel product at the time that the consumer researches price information. It would be advantageous to track prices of specific travel products and to notify the consumer when the price of a given travel product is within a consumer specified price range. It would also be advantageous to track travel products by specific attributes such as dates, fare classes, and product providers. It would also be advantageous to automatically purchase travel products that become available that meet criteria specified by a consumer.

### SUMMARY OF THE INVENTION

The present invention is directed to an electronic method for locating travel products for a user including requesting personal information from a user, receiving personal information from a user, requesting desired travel product attributes from a user, and receiving desired travel product attributes from a user. A database of travel products is searched using desired travel product attributes received from a user to select desired travel products. Selected travel products are reported to a user. A user is prompted to receive future notice about a travel product. If a user requests future notice about a travel product then the database of travel products is subsequently searched after predetermined intervals to select desired travel products using desired travel product attributes received from a user. A user is then notified of travel products selected during the subsequent searches.

In order to notify a user, the personal information requested may include a fax number or an e-mail address. A user may also be prompted to enter at least one of an address, a telephone number, an age, and whether they are a member of a travel organization.

The requested desired travel product attributes may include a travel product type and attributes of the selected travel product type. Additionally, the requested desired travel product attributes may also include a travel product provider, a date that the travel product is desired, and a price. The requested desired travel product attributes may include a travel product offered by a selected travel product provider.

In an additional embodiment of the present invention, selected travel products may be reserved for a user. Additionally, the user may be notified of a reservation and given a deadline in which to confirm the reservation. If a user does not confirm the reservation by the deadline sent to the user, then the reservation may be automatically cancelled.

In another embodiment, a user is requested to enter payment information. Payment information is then received from the user. Selected travel products are automatically purchased using payment information received from a user.

The user is prompted to enter attributes triggering notice. Attributes triggering notice are then received from the user. The notice attributes received from a user are used to select travel products in subsequent searches. In an embodiment, the notice attributes may be a price condition.

For example, a user may elect to be notified when the price drops below a particular dollar amount specified by the user, when the price is a preselected percentage lower than the price is currently, or when the price is a set amount lower than the price is currently.

Alternatively, the user may elect to be notified when the price drops to a lowest price within a preselected number of days, when the price is within a preselected percentage of the lowest price within a set number of days, or when the price is within a preselected amount of the lowest price within a set number of days.

In an additional embodiment the present invention is directed to an electronic method for locating cruises for a user. The method prompts the user to enter desired cruise attributes including at least one of a begin date, a cruise line's name, a cruise ship's name, an originating city, a cruise location, a cruise length, a cabin type, and a desired price.

The present invention is also directed to a system for obtaining travel product information for users, the system having an information server coupled to a computer network, a user terminal coupled to the computer network, a first database coupled to the computer network for storing airplane flight information. A second database is coupled to the computer network for storing hotel information, a third database is coupled to the computer network for storing rental car information, and a fourth database coupled to the computer network for storing cruise information. The information server is configured to receive user contact information and desired travel product attributes from the user terminal, search at least one of the first database, second database, third database and fourth database for travel products having the desired travel product attributes and submit travel product information using the received contact information.

In an additional embodiment, the information server is further configured to reserve travel products having the received desired travel product attributes and to notify the user of the reservation using the received contact information. In another embodiment, the information server is further configured to receive payment information from the user terminal, purchase travel products having the received desired travel product attributes using the received payment information, and notify the user of the purchase using the received contact information.

### BRIEF DESCRIPTION OF THE DRAWINGS

These and other features and advantages of the present invention will be better understood by reference to the following detailed description when considered in conjunction with the accompanying drawings wherein:

FIG. 1 is a block diagram showing the relationship of parts of a system for monitoring travel products in accordance with an embodiment of the present invention;

FIG. 2 is a block diagram of a system for monitoring travel products in accordance with an embodiment of the present invention;

FIG. 3 shows the contents of a database of airline flight prices according to an embodiment of the present invention;

FIG. 4 shows the contents of a database of hotel room prices according to an embodiment of the present invention;

FIG. 5 shows the contents of a database of car rental prices according to an embodiment of the present invention;

FIG. 6 shows the contents of a database of cruise prices according to an embodiment of the present invention;

FIG. 7 is a flowchart showing a process for obtaining travel product information according to an embodiment of the present invention;

FIG. 8 is a flowchart showing a process for presenting travel product information for purchase or for future notification according to an embodiment of the present invention; and

FIG. 9 is a flowchart showing processes for automatic purchase, automatic reservation, and notification according to an embodiment of the present invention.

### DETAILED DESCRIPTION OF THE INVENTION

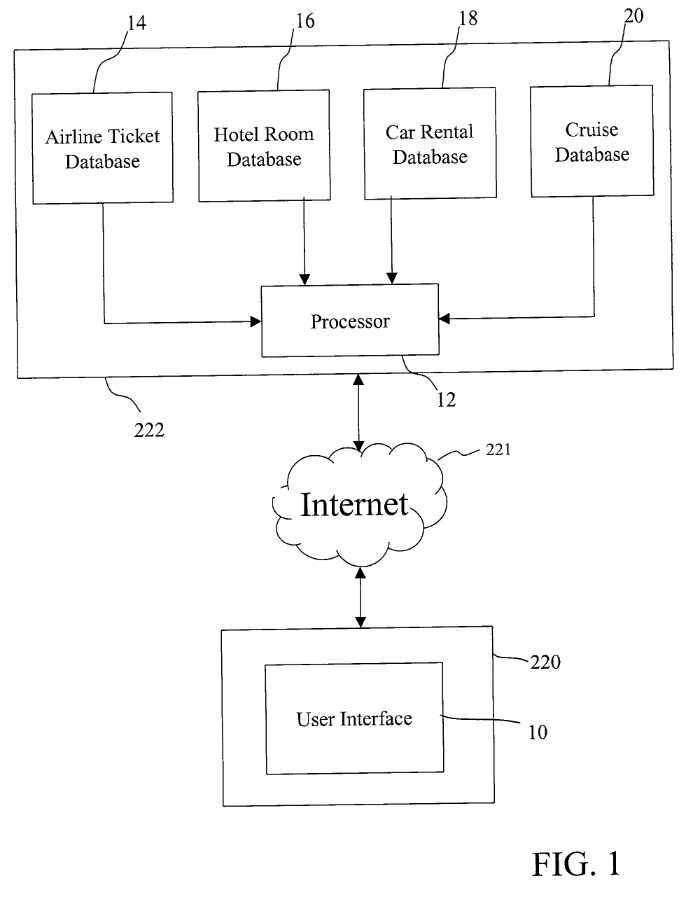

An overview of an embodiment of the present invention is shown in FIG. 1. The system functions between a user device 220 and a server 222 communicating through the Internet 221. The server communicates a user interface 10 to the user device. The user is prompted to enter personal information and desired travel product attributes through the user interface. The user device is coupled to a processor 12 within the server. The processor is in turn linked to a plurality of travel product databases. For example, the processor may be linked to an airline ticket database 14, a hotel room database 16, a car rental database 18 and a cruise database 20. Once desired travel product attributes are entered into the user interface 10 by a user, the user device communicates with the processor 12. The processor, at predetermined time intervals, reviews the travel product databases to select travel products having the desired travel product attributes.

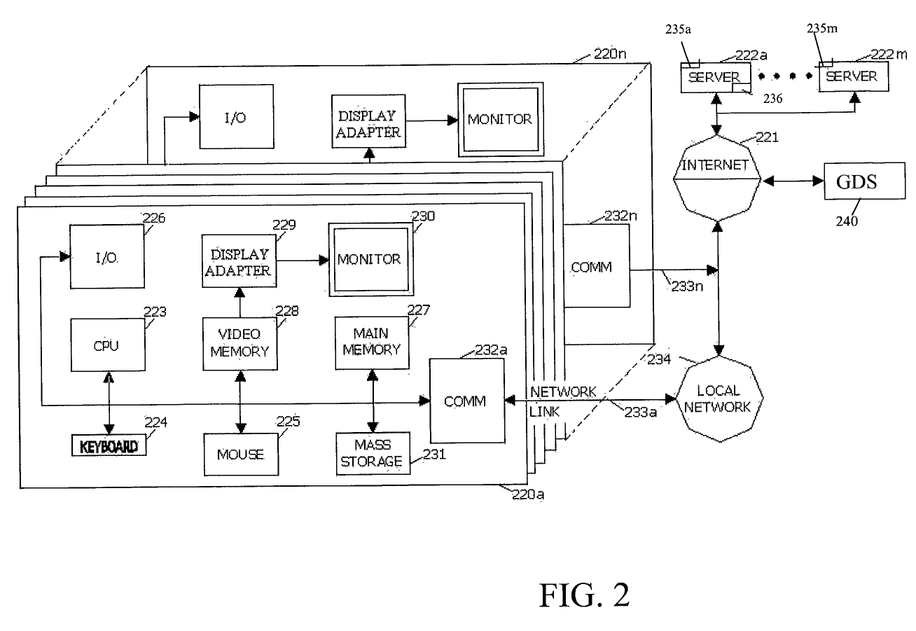

FIG. 2 shows a block diagram of a typical Internet client/server environment used by the users and servers in one embodiment of the present invention. User devices 220a-220n used by the users are connected to the Internet 221 through communication links 233a-233n. optionally, a local network 234 may serve as the connection between some of the user devices 220a-220n, such as the user device 220a and the Internet 221. Servers 222a-222m are also connected to the Internet 221 through respective communication links. Servers 222a-222m include information and databases accessible by the user devices 220a-220n. In one embodiment of the present invention, databases for storing travel product information reside on at least one of the servers 222a-222m and are accessible by users using one or more of the user devices 220a-220n to obtain travel product information.

In an alternative embodiment of the present invention, the travel product databases are stored on a Global Distribution System 240. Travel product information, including current travel prices and availability, is gathered from travel product providers and stored on the Global Distribution System 240. The Global Distribution System 240 is accessible by at least one of the servers 222a-222m through the Internet.

In yet another alternative embodiment, the travel product databases are stored on computers of the individual travel product providers. Each of the travel product databases stored on computers of the individual travel product providers contains travel product information, including current prices and availability. The databases stored on computers of the individual travel service providers are accessible by at least one of the servers 222a-222m through the Internet.

In one embodiment of the present invention, each of the user devices 220a-220n typically includes a central processing unit (CPU) 223 for processing and managing data; and a keyboard 224 and a mouse 225 for inputting data. A main memory 227 such as a Random Access Memory (RAM), a video memory 228 for storing image data, and a mass storage device 231 such as a hard disk for storing data and programs are also included in a typical user device. Video data from the video memory 228 is displayed on a Display screen 230 by a display adapter 229 under the control of the CPU 223. A communication device 232, such as a modem, provides access to the Internet 221. optionally, one or more of user devices 220a-220n may be connected to a local network 234. An Input/Output (I/O) device 226 reads data from various data sources and outputs data to various data destinations.

Servers (hosts) 222a-222m are also computers and typically have architecture similar to the architecture of user devices 220a-220n. Generally, servers differ from the user devices in that servers can handle multiple telecommunications connections at one time. Usually, servers have more storage and memory capabilities, and higher speed processors. Some server (host) systems may actually be several computers linked together, with each handling incoming web page requests. In one embodiment, each server 222a-222m has a storage medium 235a-235m, such as a hard disk, a CD drive, or a DVD for loading computer software.

When software such as the software responsible for executing the processes in FIGS. 1 and 3 to 9 is loaded on the server 222a, an off-the-shelf web management software or load balancing software may distribute the different modules of the software to different servers 222a-222m. A server may utilize an operating system such as DOS, Microsoft Windows, or Linux. The server may use off the shelf, or open source software to generate and serve web pages. In an embodiment, the server uses Apache server software to generate and serve web pages. The page generating software generates web pages that have, for example, hypertext markup language (HTML) and Javascript components. Additionally, the server may be protected from unauthorized access by the use of a firewall, such as one produced by Checkpoint.

Therefore, in one embodiment, the computer program responsible for executing the present invention resides on one or more servers. Databases to carry out the processes of FIGS. 1 and 3 to 9 may be created, maintained and edited in many different types of database software including Access, FoxPro, and Oracle. In one embodiment of the present invention the database software is made by Oracle.

An exemplary web site location 235 is shown on server 222a in FIG. 2. The web site 235 is the user interface for accessing the database described below. The web site 236 has a unique address that is used by the users to access server 222a (in this example) and the web site location on the server 222a. The computer software for executing the processes of the present invention may also reside on the web site 236.

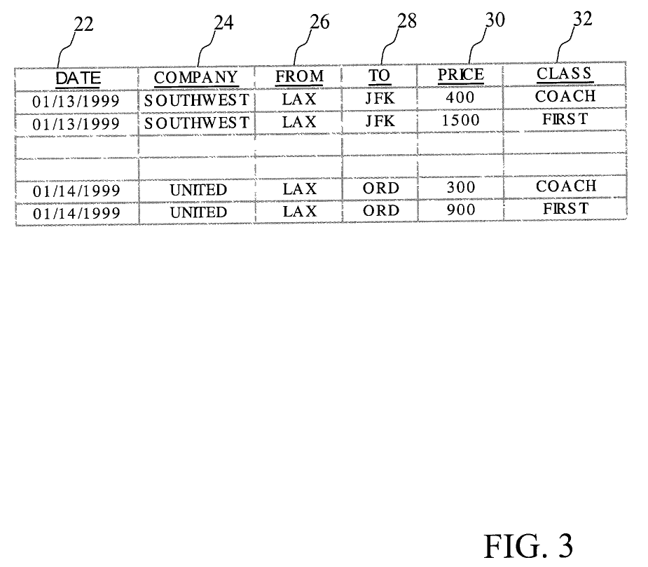

FIG. 3 shows a representative portion of an exemplary airline ticket database 14. As shown in FIG. 3, an airline ticket database, according to an embodiment of the invention, contains several different fields. Those fields include departure date 22, airline company 24, departure location 26, arrival location 28, price 30, and the seat class of the entry 32.

The airline ticket database may contain several additional price fields containing discount information corresponding to certain qualifications, such as the age of the person flying, whether a round-trip ticket is purchased, and whether other travel products are also purchased. In an additional embodiment, the airline ticket statistical database may contain information about the meals, movies, and consumer ratings for each flight, which may be communicated to a user, to help them select a flight.

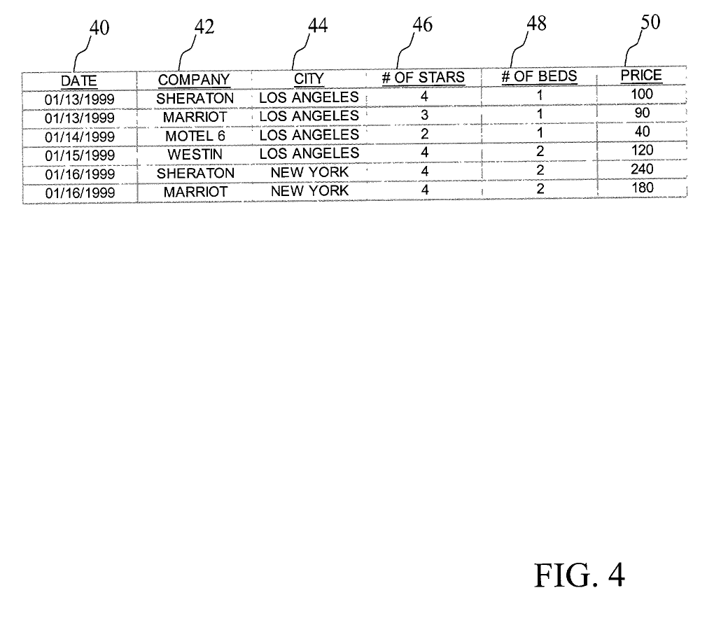

FIG. 4 shows a representative portion of an exemplary hotel room database 16. The hotel room database may include fields for a date upon which the room is available 40, a hotel company 42, a city in which the hotel is located 44, a ranking of the hotel such as the number of stars that it has received from a particular guide book 46. Additional information about hotels may include the number of beds in the hotel room 48, and a price 50.

The hotel room database may contain several additional price fields containing discount information corresponding to certain qualifications, such as the age of the room occupant, the number of nights stayed, and whether other travel products are also purchased. In an additional embodiment, the hotel room database may contain additional information, such as whether the rooms in the hotel have cable television and whether the hotel has air conditioning which may be communicated to a user to help them choose a hotel.

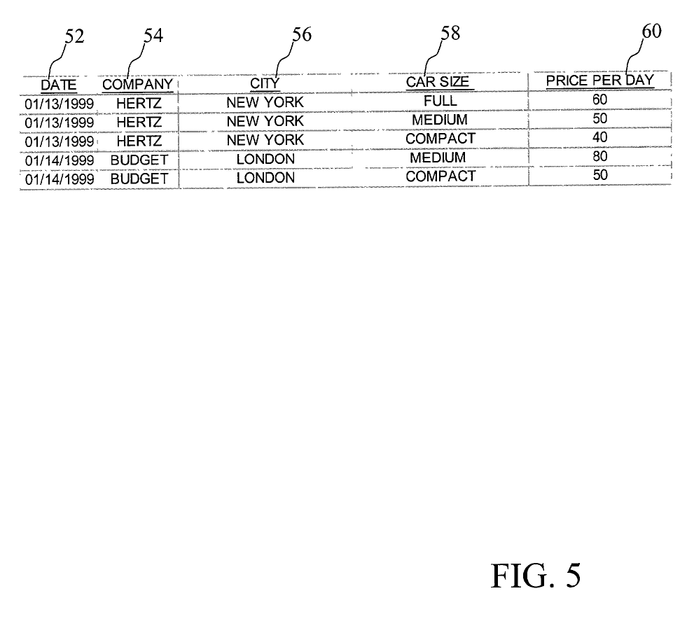

FIG. 5 shows a representative portion of an exemplary car rental database 18. A car rental database according to an exemplary embodiment of the present invention contains fields for a date upon which the car rental begins 52, a car rental company 54, a city in which the car will be rented 56. The car rental database also contains a field for the type of car that is being rented 58, for example, full size, medium size, and compact size. The table also contains a field for the price per day 60. For example, a full size car in the city of New York from Hertz on Jan. 13, 1999 may cost $60 per day.

The car rental database may contain several additional price fields containing discount information corresponding to certain qualifications, such as the age of the car renter, the number of days the car is rented, and whether other travel products are also purchased. In an embodiment, the car rental database may contain additional information, such as whether the car has air conditioning, whether gas is included, whether there is an airport return site, and any mileage limitations and charges, which may be communicated to a user to help them choose a rental car.

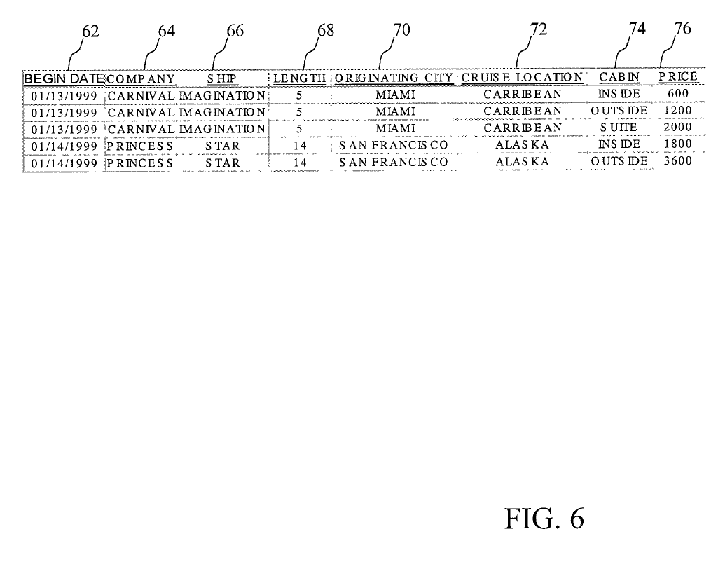

FIG. 6 shows an exemplary database of cruise information. An exemplary database of cruise information may contain a cruise begin date 62, a cruise line's name 64, a cruise ship's name 66, a cruise duration 68, an originating location 70, a cruise location 72, a cabin class 74, and a price 76.

The cruise information database may contain several additional price fields containing discount information corresponding to certain qualifications, such as the age of the traveler, membership in a travel organization, and whether other travel products are also purchased. In an embodiment, the cruise information database may contain additional information, such as whether the cruise is for single people, whether the cruise has formal dining, whether there are excursions, and additional ports of call.

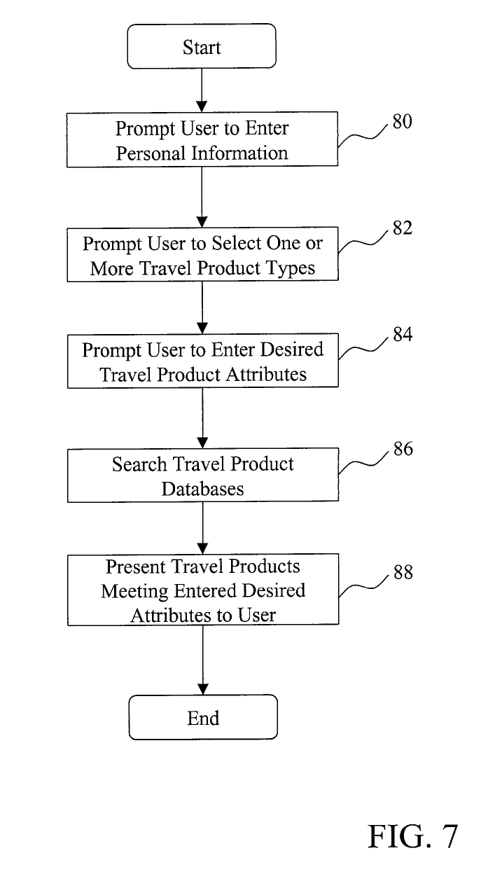

As shown in FIG. 7, when a user, using a user device, accesses the server, the server generates a user interface prompting the user to enter information. Initially, the server prompts the user to enter personal information, box 80. For example, a user is prompted to enter a first name, a last name, an address, a telephone number, a fax number, and an e-mail address. In an additional embodiment, a user may be prompted for additional personal information such as their age, birth date, marital status, how many children they have, and whether they are members of any travel clubs.

In an alternative embodiment, the server is able to obtain personal information about the user from information automatically passed to the server by the user's computer. In this embodiment, the server may prompt the user to confirm that the automatically obtained information is correct.

In another embodiment, the user is prompted to open an account on the server. If the user opens an account on the server, any personal information entered is stored and is later accessible. If the user elects to open an account on the server, then the user is prompted to enter a username and password that they wish to use to access the system. Once the user has opened an account, when they return to the server, the user is prompted to enter their username and password to gain access to their account.

The user is prompted to select a category of travel product that they wish to purchase, box 82. In an exemplary embodiment, the user is prompted to select from airline tickets, hotel rooms, rental cars or cruise packages. In alternative embodiments, users may be prompted to select other types of travel products, such as tours. In an alternative embodiment, the user is prompted to select multiple travel products.

Depending on the type of travel product selected by the user, the user is prompted to enter desired travel product attributes, box 84. If the user has selected multiple travel products then the user is prompted to enter desired travel product attributes for all of the selected travel products.

If the user selects airline tickets as the desired travel product, then the user is prompted to enter one or more attributes of their preferred airline tickets. For example, the user is prompted to enter a particular airline, a departure location, as well as a departure date. The user is also prompted to enter a destination city, a seat class, a specific flight number, and a desired price. In an additional embodiment, the user is prompted to select from one way or roundtrip flights. If the user selects roundtrip flights, then the user is prompted to select a return date that they wish to return to the departure city. A user may select a very specific airline travel product, for example, Southwest Airlines Flight #100, business class, from Los Angeles International Airport to San Francisco International Airport on May 2, 2000, departing at 9:00 a.m.

If the user selects hotel rooms as the desired travel product, then the user is prompted to enter one or more specific attributes regarding their preferred hotel rooms. For example, the user is prompted to enter a starting date for their stay, a hotel company name, a city, and a desired price for the hotel room. A user may also be prompted to select a given star categorization of a hotel. The user is prompted to enter the number of nights that they intend to stay in the hotel room. In another embodiment, the user is prompted to enter multiple entries for each attribute, such as 5 or 4 star hotels.

If the user selects car rental products as the desired travel product, then the user is prompted to enter one or more specific attributes regarding their preferred car rental. For example, the user is prompted to select a date for starting car rental and a city in which they wish to rent the car. The user is prompted to select a car rental company. The user is prompted to choose between different sizes of cars, such as full, medium, or compact cars. The user is prompted to enter the number of days that they wish to rent a car and a desired price for the car rental.

If the user selects cruises as their desired travel product, then the user is prompted to enter one or more specific attributes regarding their preferred cruise. For example, the user is prompted to enter a cruise begin date, a cruise line's name, and a cruise ship's name. Additionally, the user is prompted to enter an originating city and a cruise location. The user is also prompted to enter a preferred cruise length. The user is also prompted to enter a preferred cabin type, such as inside stateroom, outside stateroom, or suite. Additionally, the user is prompted to enter a desired price for the cruise.

In an additional embodiment, the user is prompted to enter more than one cruise line and more than one cruise ship name. In another embodiment, the user is prompted to enter the type of facilities that the user would like on the ship and in the ports of call. The server may use facilities preferences to search cruise itineraries for cruises that would be desirable to the user.

In an additional embodiment, the user may enter a range of dates instead of a specific date for a travel product. For example, a user may enter a month, a season, or a set of beginning and ending dates during which the desired travel product should be obtained. In yet another embodiment, additional travel product attributes are selected from user interests either obtained directly from the user or obtained from website usage by a user. For example, user interest in culture or history may be obtained from search terms used by the user on a website. The user interest in culture or history may be used to search travel product description information to help select travel products that would be interesting to the user.

In an embodiment, once the consumer has entered the travel product attribute information, the processor searches the travel product databases for travel products that meet the criteria entered by the user, box 86. Additionally, some travel product information may be contained in databases kept by individual travel product providers. Queries are submitted to the individual travel product providers based upon user entered information. For example, in the case of airline tickets, the server submits the user entered departure location, departure date, destination city, and seat class. The information returned by the individual travel product providers may be further filtered by the server.

Following the search, product information corresponding to the travel product attributes entered by the user is presented to the user, box 88. For example, if the user requested cruise information and entered desired cruise attributes, the processor returns cruise itineraries corresponding to the desired cruise attributes. The server attempts to report cruises most likely to interest the user. For example, if the user did not select a preferred cabin type, or selected a range of cabin types, the best cabin type fitting the other attributes specified by the user is displayed for the user.

If a large number of travel products having the attributes entered by the user are found, such as over 100, the user is prompted to enter additional attributes to narrow the travel products further. If no travel products meeting the attributes entered by the user are found, the user is prompted to change one or more attributes. Alternatively, as explained further below, the user is prompted to be notified if any travel products having the entered attributes become available, or become available at a lower price.

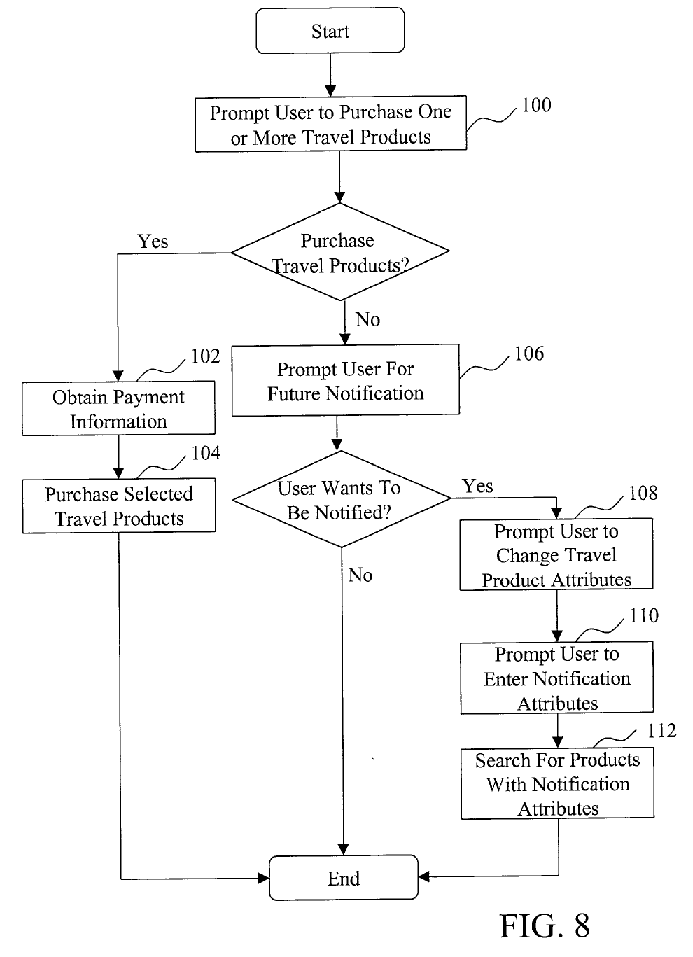

As shown in FIG. 8, when travel products meeting the attributes entered by the user are displayed, the user is prompted to purchase one or more travel products, box 100. If the user elects to purchase one or more travel products, then the user is prompted to enter payment information, box 102. If the user has an account stored on the server with payment information, then the user's payment information is automatically obtained. Once payment information is obtained, the server purchases the travel product from the travel product vendor, box 104.

Alternatively, the user is prompted to have the server monitor a travel product and to notify the user through the personal contact information provided to the server when one or more attributes, such as the price, changes, box 106. If the user elects continued monitoring and notification, the user is prompted to modify the desired travel product attributes, box 108. The user may maintain the travel product attributes already selected, or the user may specify additional attributes.

Additionally, the user is prompted to enter notification attributes, box 110. For example, a user may elect to be notified when the price of a particular travel product drops below a particular dollar amount, when the price is a preselected percentage lower than the price is currently, or when the price of a particular travel product is a set amount lower than the price is currently. If the user selects a percentage lower than the current price or a set amount lower than the current price, the system calculates a particular dollar amount for the user. The particular dollar amount, either calculated or specified by the user, is saved into memory and considered when searching the travel product databases.

Alternatively, a user may elect to be notified when the price of a particular travel product drops to the lowest price within a preselected number of days or weeks, when the price is within a preselected percentage of the lowest price within a set number of days or weeks, and when the price is within a preselected amount of the lowest price within a set number of days or weeks.

In an embodiment, in order to determine price changes over time, every day the system saves the current price and date to a memory to create a log. Thereafter, when the system searches the database, the system compares the price and date at the time of search to the prices and dates stored in memory to determine if the conditions specified by the user are met. Thereby, the system can determine whether the price at any given time is the lowest, within a specified percentage of the lowest, or within a specified dollar amount of the lowest price, over a time period specified by the user.

For example, if the user requests to be notified of a particular cruise when the price of the cruise is the lowest it has been in 10 days, then the system would check each subsequent day's price against the previous 9 days. If the current price was lower than the previous 9, then the system would notify the user. Alternatively, if the current price was not lower than the previous 9 days, then the system would continue to check the price of the travel product every day, each day comparing that day's price to the 9 days prior to that day.

Additionally, a user may elect to have the server notify them at a set interval with the current price of a selected travel product. In another embodiment, the notification may contain the current price as well as one or more past prices of the travel product.

The system periodically searches the travel product databases to determine whether any travel products meeting the criteria entered by the user exist, box 112. If a travel product meeting the criteria specified by the user is found, then the user is notified and prompted to purchase the travel product.

In an additional embodiment, the user may elect to have the server automatically reserve travel products meeting desired attributes if possible. For example, if the travel product found is a cruise, the processor automatically reserves the cruise for the user. The processor then notifies the user about the reservation using the contact information provided by the user.

The notification sent to the user prompts the user to respond to the reservation by accessing the website to purchase the travel product. In an embodiment, depending on the amount of time that the travel product may be reserved, the user is provided with a deadline by which to respond. If the user does not respond by the provided deadline then the reservation is automatically cancelled.

In an alternative embodiment of the present invention, the user is also prompted to agree to automatic purchasing of travel products meeting the criteria specified by the user. If the user selects this option, and payment information has not yet been obtained for the user, then the user is prompted to enter payment information. In this alternative embodiment, when travel products are located that meet the criteria specified by the user, the travel products are automatically purchased using the payment information provided by the user. Once a purchase is effected, a notice including any available purchase revocation period, is sent to the user. If revocation is possible, the notification to the user also includes a hotlink to revoke the purchase.

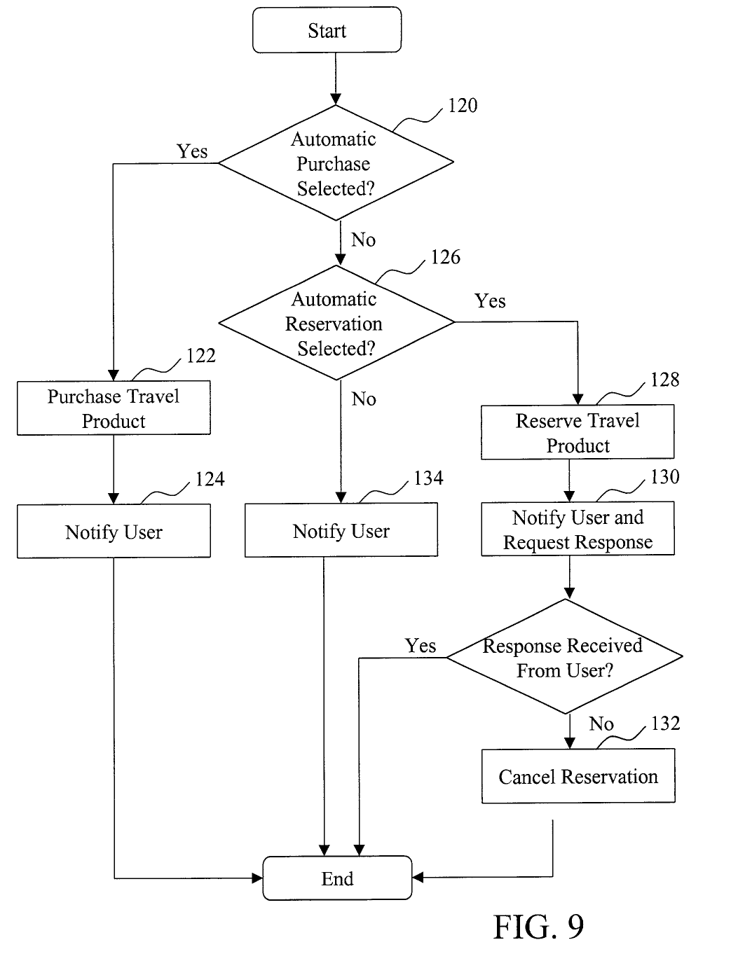

FIG. 9 is a flowchart showing different notification options according to an embodiment of the present invention. Once the server identifies a travel product meeting the product attributes specified by the user and meeting the notification attributes entered by the user, the system checks to see if the user has authorized automatic purchasing of the travel product, box 120. If the user has authorized automatic purchase, the system purchases the travel product, box 122, and notifies the user of the purchase, box 124.

If the user has not authorized automatic purchase, then the system checks to see if the user authorized automatic reservation, box 126. If the user authorized automatic reservation, then the server reserves the travel product, box 128. The server notifies the user of the reservation and, depending on the amount of time that the reservation may be maintained, gives the user a deadline by which to contact the server or have the reservation automatically cancelled, box 130. At the specified deadline the server checks to see if there has been a response from the user, box 132. If the user has not responded to the notification, then the server cancels the reservation, box 134. If the user has not selected automatic purchasing or automatic reservation, then the system notifies the user of the availability of the travel product 136.

The preceding description has been presented with reference to presently preferred embodiments of the invention. Workers skilled in the art and technology to which this invention pertains will appreciate that alterations and changes in the described structure may be practiced without meaningfully departing from the principle, spirit and scope of this invention. Accordingly, the foregoing description should not be read as pertaining only to the precise system and method described and illustrated in the accompanying drawings, but rather should be read consistent with and as support for the following claims, which are to have their fullest and fairest scope.

What is claimed is:

1. A method utilizing a computer for locating travel products for a user comprising:
receiving by the computer of personal information from a user;
receiving by the computer of desired travel product attributes from a user;
searching a database of travel products to select desired travel products using desired travel product attributes received from a user;
reporting travel products selected to a user;
receiving a request for future notice about a travel product from a user;
automatically searching through a database of travel products after a predetermined time interval to select desired travel products using desired travel product attributes received from a user; and
notifying a user of selected travel products.

2. The method utilizing a computer for locating travel products of claim 1 wherein receiving personal information further comprises receiving from the user at least one of the group consisting of an address, a telephone number, an age, and whether the user is a member of a travel organization.

3. The method utilizing a computer for locating travel products of claim 1 wherein receiving desired travel product attributes further comprises receiving from the user a travel product type and attributes of the selected travel product type.

4. The method utilizing a computer for locating travel products of claim 3 wherein receiving desired travel product attributes further comprises receiving from the user at least one of the group consisting of a travel product provider, a date that the travel product is desired, and a price.

5. The method utilizing a computer for locating travel products of claim 4 wherein receiving desired travel product attributes further comprises receiving from the user a travel product offered by a selected travel product provider.

6. The method utilizing a computer for locating travel products of claim 1 further comprising automatically reserving travel products selected for a user.

7. The method utilizing a computer for locating travel products of claim 6 further comprising notifying a user of a reservation, the notice having a deadline for confirmation of the reservation.

8. The method utilizing a computer for locating travel products of claim 7 further comprising cancelling a reservation if a user does not confirm the reservation by the deadline sent to the user.

9. The method utilizing a computer for locating travel products of claim 1 further comprising:
receiving by the computer of payment information from a user; and
automatically purchasing selected travel products for a user using payment information received from a user.

10. The method utilizing a computer for locating travel products of claim 1 further comprising:
receiving by the computer of notice attributes from a user, the notice attributes being attributes triggering notice; and
wherein notice attributes received from a user are used to select the selected travel products.

11. The method utilizing a computer for locating travel products of claim 10 wherein receiving notice attributes further comprises receiving from the user a price condition for a travel product, the price condition being at least one of the group consisting of when the price drops below a particular dollar amount, when the price is a preselected percentage lower than the price is currently, and when the price is a set amount lower than the price is currently.

12. The method utilizing a computer for locating travel products of claim 10 wherein receiving notice attributes further comprises receiving from the user a price condition for a travel product, the price condition being at least one of the group consisting of when the price drops to a lowest price within a preselected number of days, when the price is within a preselected percentage of the lowest price within a set number of days, and when the price is within a preselected amount of the lowest price within a set number of days.

13. A method utilizing a computer for locating cruises for a user comprising:
receiving by the computer of personal information from a user;
receiving by the computer of desired cruise attributes from a user, the cruise attributes including at least one of the group consisting of a begin date, a cruise line's name, a cruise ship's name, an originating city, a cruise location, a cruise length, a cabin type, and a desired price;
searching a database of cruise information to select a cruise using desired cruise attributes received from a user;
reporting selected cruises to the user;
receiving by the computer of a request for future notice about a cruise from a user;
automatically searching a database of cruise information after a predetermined interval to select a cruise using desired cruise attributes received from a user; and
notifying a user of selected cruises.

14. A system for obtaining travel product information for users comprising:
an information server coupled to a computer network;
a user terminal coupled to the computer network;
a travel product database coupled to the computer network for storing travel product information; and
wherein the information server is configured to receive personal contact information from the user terminal; receive desired travel product attributes from the user terminal; search the travel product database to select travel products having the desired travel product attributes received from the user terminal; report selected travel product information to the user terminal; receive a request for future notice about a travel product from the user terminal; automatically search through the travel product database after a predetermined time interval to select travel products having the desired travel product attributes received from the user terminal; and notify the user terminal of selected travel products.

15. The system for obtaining travel product information for users of claim 14 further comprising:
an airplane flight database coupled to the computer network for storing airplane flight information;
a hotel database coupled to the computer network for storing hotel information;
a rental car database coupled to the computer network for storing rental car information; and
a cruise database coupled to the computer network for storing cruise information.

16. The system for obtaining travel product information for users of claim 14 wherein the information server is further configured to receive personal information including at least one of the group consisting of an address, a telephone number, an age, and whether a user is a member of a travel organization.

17. The system for obtaining travel product information for users of claim 16 wherein the information server is further configured to receive desired travel product attributes including a travel product type and attributes of the selected travel product type.

18. The system for obtaining travel product information for users of claim 17 wherein the information server is further configured to receive desired travel product attributes including at least one of the group consisting of a travel product provider, a date that the travel product is desired, and a price.

19. The system for obtaining travel product information for users of claim 18 wherein the information server is further configured to receive desired travel product attributes including a travel product offered by a selected travel product provider.

20. The system for obtaining travel product information for users of claim 18 wherein the information server is further configured to receive notice attributes from the user terminal; and use the notice attributes to select the selected travel products.

21. The system for obtaining travel product information for users of claim 20 wherein the information server is further configured to receive notice attributes including a price condition for a travel product, the price condition being at least one of the group consisting of when the price drops below a particular dollar amount, when the price is a preselected percentage lower than the price is currently, and when the price is a set amount lower than the price is currently.

22. The system for obtaining travel product information for users of claim 20 wherein the information server is further configured to receive notice attributes including a price condition for a travel product, the price condition being at least one of the group consisting of when the price drops to a lowest price within a preselected number of days, when the price is within a preselected percentage of the lowest price within a set number of days, and when the price is within a preselected amount of the lowest price within a set number of days.

23. The system for obtaining travel product information for users of claim 14 wherein the information server is further configured to reserve travel products having the received desired travel product attributes and to notify the user of the reservation using the received contact information.

24. The system for obtaining travel product information for users of claim 15 wherein the information server is further configured to receive payment information from the user terminal, purchase travel products having the received desired travel product attributes using the received payment information, and notify the user of the purchase using the received contact information.

25. A computer readable medium having stored thereon a set of instructions including instructions for obtaining travel product information, the instructions, when executed by a microprocessor cause the microprocessor to perform the steps of:
receiving personal information from a user;
receiving desired travel product attributes from a user;
searching a database of travel products to select desired travel products using desired travel product attributes received from a user;
reporting travel products selected to a user;
receiving a request for future notice about a travel product from a user;
automatically searching through a database of travel products after a predetermined time interval to select desired travel products using desired travel product attributes received from a user; and
notifying a user of selected travel products.
